(19) United States
(12) Patent Application Publication
(10) Pub. No.: US 2011/0113365 A1
(43) Pub. Date: May 12, 2011

(54) SCROLLING LARGE DATA SETS

(75) Inventors: Randy S. Kimmerly, Woodinville, WA (US); James Randall Flynn, Seattle, WA (US)

(73) Assignee: MICROSOFT CORPORATION, Redmond, WA (US)

(21) Appl. No.: 12/615,235

(22) Filed: Nov. 9, 2009

(51) Int. Cl. G06F 3/048

(52) U.S. Cl. 715/806

(57) ABSTRACT

The display in a scrollable window of large data sets, which is not loaded into memory all at one time. Rather, a control module manages the scrollable window by repeatedly estimating data ranges of the data set that are to be either presently displayed or that may soon be displayed in the scrollable window. In response to each of at least some of such estimations, the estimated data ranges are then loaded into memory without loading the entire data set into memory. At least portions of the loaded data may then be displayed in the scrollable window. If the scrollable window is scrolled to a particular portion of the data set, but that portion of the data set is not yet loaded into memory, scrolling is permitted to that area even though the actual data is populated into the window after loading.

### BACKGROUND

Computing system now provide sophisticated user interface in which content is displayed via windows and frames (collectively referred to as a “window” herein). Typical data browsing/visualization applications display information using standard user interface controls such as lists, tables, and trees. These controls typically have scrollbars that allow users to easily move through the data, since it is likely that not all of the data will fit on the screen at one time. However, these controls are generally not usable for data sets that are too large to fit in memory. In these cases, applications will typically use a page-based user interface that presents a fixed-size subset (i.e., a “page”) of data records, along with affordances to move forward/backward a page at a time. More advanced versions allow navigation to particular pages by number, or other data criteria such as first letter, and such. The key point is that the standard scrollbar behavior is lost with such controls.

### BRIEF SUMMARY

Embodiments described herein relate to the display of large data sets in a scrollable window. In one embodiment, the data set is not loaded into memory all at one time. Rather, a control module manages the scrollable window by repeatedly estimating data ranges of the data set that are to be either presently displayed or that may soon be displayed in the scrollable window. In response to each of at least some of such estimations, the estimated data ranges are then loaded into memory without loading the entire data set into memory. At least portions of the loaded data may then be displayed in the scrollable window. In one embodiment, if the scrollable window is scrolled to a particular portion of the data set, but that portion of the data set is not yet loaded into memory, the scrolling function is enabled anyway without waiting for the data to arrive before scrolling is permitted to that area.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a computing environment that includes a display that displays a scrollable window;

FIG. 3 illustrates a hierarchically structured data sources which are to be navigated by the control module to obtain the appropriate data for display in a scrollable window; and

FIG. 4 illustrates a flowchart of a method for enforcing scrolling functions in scrollable windows that are to display data sets that are not all in memory at the same time.

### DETAILED DESCRIPTION

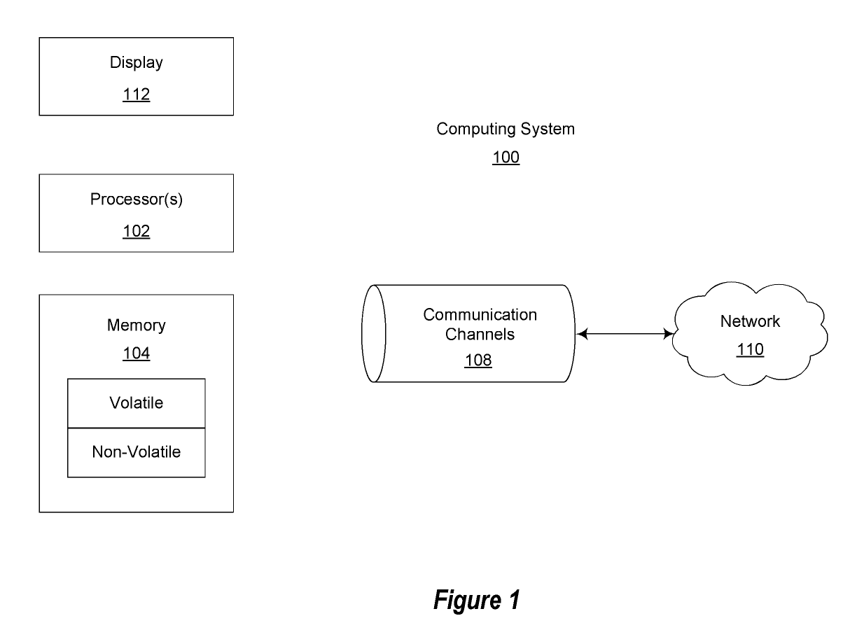

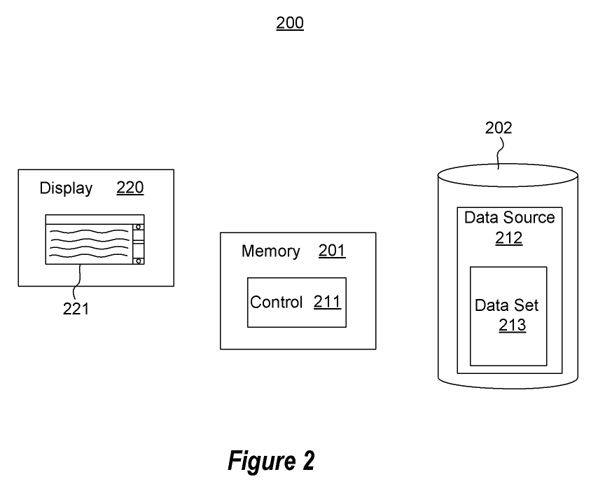

In accordance with embodiments described herein, the display of data sets in a scrollable window is described, even though not all of the data set is loaded into memory at one time. First, some introductory discussion regarding computing systems will be described with respect to FIG. 1. Then, various embodiments of use of a scrollable window for large data sets will be described with reference to FIGS. 2 through 4.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computing system 100 also may include a display 112 on which may be displayed a scrollable window. In accordance with the principles described herein, and as described with respect to FIGS. 2 through 4, large data sets that are not all loaded into memory at one time, may still be displayed in the scrollable window in accordance with the principles described herein.

Embodiments within the scope of the present invention also include a computer program product having computer-readable media for carrying or having computer-executable instructions or data structures stored thereon. Such computer-readable media (or machine-readable media) can be any available media that can be accessed by a general purpose or special purpose computer. By way of example, and not limitation, such computer-readable media can comprise physical storage and/or memory media such as RAM, ROM, EEPROM, CD-ROM, DVD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates an environment 200 that includes a display 220 that displays a scrollable window 221. The environment 200 also includes a control module 211 in memory system 201 that functions as described further herein. The environment 200 further includes a data source 212 in persistent storage 202, that data source 212 including or managing accessing to a data set 213 that is to be scrolled through. The scrollable window 221 may be horizontally scrollable and/or vertically scrollable. However, in a few examples given hereinafter, the scrollable window will be described as being vertically scrollable, with each record occupying vertical space in the scrollable window. However, those of ordinary skill in the art will appreciate, after having read this description, that the scrollable window may also be horizontally scrollable consistent with the principles described herein.

The environment 200 may be implemented in a computing system, an example of which being described above with respect to the computing system 100 of FIG. 1. In the case of FIG. 1, the memory system 201 may be the volatile portion of memory 104, and the control module 211 may be instantiated in response to the execution of computer executable instructions present in persistent storage 202, which takes the form of the persistent portion of memory 104. The data source 212 may be a data source that maintains the data set 213 in the persistent portion of memory 104 having selective portions loaded into the voltage portion of memory 104 as directed by the control module 211. The control module 211 may manage one or more scrollable windows being or to be displayed in a display. For instance, if the control module 211 is implemented in the computing system 100 of FIG. 1, the one or more scrollable windows may be displayed on the display 112. In one embodiment although not required within the broader principles described herein, there may be a one to one correspondence between a control module and a scrollable window such that a control module manages one scrollable window.

The control module 211 repeatedly estimates data ranges of the data set 213 that are either to be presently displayed or which are soon to be displayed in the scrollable window 221. The control module 211 uses its control logic to estimate how many records may be displayed in the current scrollable window. If the control module 211 underestimates the number of records needed, the control module 211 may request additional records to fill the scrollable window. If the control module 211 overestimates the number of records needed, the control module 211 may have extra record(s) that are not within the display. The control module 211 may use heuristics regarding scrolling behavior to estimate future scrolling activity, and then request records based on estimated future scrolling activity. For instance, if the user predictably scrolls up, then down, then up, then down, and so forth in order, the user may be actively comparing two portions of the data set. In that case, the control module 211 may predict a further scroll up after some scroll down activity. In that case, the control module 211 may elect to proactively retrieve data before the portion of the data set that is currently being displayed in response to the end of a prior scroll down gesture. The control module may cache a certain number of data items surrounding the items actually being displayed, such that scrolling within the cached range does not incur the cost of retrieving the data from the data source. This cache can be maintained asynchronously as the user scrolls, in such a way as to not block interactivity with the control, but attempt to keep the cache range fixed around the displayed range of items.

The scrollable window might be, for example, a scrollable list, a scrollable table, a scrollable tree, or any other scrollable control. In response to at least some of the estimations, and with the aim of facilitating scrolling activity by appropriately populating the scrollable window 221 with the corresponding data for the area of the data set scrolled to, the control module 211 loads the estimated data ranges from the data source 212 into the volatile memory system 201, where the data can be more readily consumed by the scrollable window 221. Using this mechanism, since all of the data set 213 is not loaded into the memory system 201 at any given time, even very large data sets can be displayed in the scrollable window 221.

The manner in which the control module 211 requests the data from the data source 212 is not important to the broader principles described herein. However, in one embodiment, the data source 212 and the control module 211 communicate in an interface in which the data source 212 may notify the control module 211 of the total number of records in the data set. This aids in the control module 211 displaying a relative position of the currently displayed data within the context of the overall data set. This might be accomplished using, for example, a thumb control positioned appropriately within the scroll bar. In that case, the size of the thumb might also represent something about the amount of data being currently displayed as compared to the total size of the data set. Using this interface, the control module 211 may request a portion of the data set 213 using index and size, the index being a position number of a record within the data size, and the size representing the total number of records to be loaded relative to the position of the index.

The control module 211 may enforce the scrolling function of the scrollable window 221 even if not all of the data to be displayed in the scrolled state of the scrollable window 221 is yet loaded from the data source 212 into the memory system 201. Thus, upon the user activating a scrolling function, the scrolling function may immediately be reflected by the state of the scrollable window 221, even if not all of the data to be displayed is yet loaded into the memory system 201 or displayed in the scrollable window 221. Examples of scrolling functions that the scrollable window 221 may respond quickly to include, 1) a scroll directional movement in which the scrollable window is moved incrementally one direction or another, 2) a page directional movement in which the scrollable window is moved by a larger predetermined segment (such as a page) on one direction or another, or 3) a jump operation in which the scrollable window is moved arbitrarily to another segment of the data set by the user dragging the thumb of the scroll control. Thus, the user has the feel of working with a genuine scrollable window even though the data set is not all present in memory at one time, and even if the data is not yet ready to be populated into the scrollable window (e.g., due to the data not yet being loaded from the persistent data source into memory).

In one embodiment, if the scrollable window 221 is scrolled or otherwise navigated to a portion of the data set 213 that is not yet loaded from the data source 212 into the memory system 201, the control module 211 may instead display a placeholder for the missing data until the missing data is loaded into the memory system 201. At that point, the missing data may then be displayed in lieu of the placeholder.

The placeholder might be anything that conveys to the user that the data is not yet displayed. As one example, the placeholder might be a progress indicator representing a status of the loading of the missing data from the data source into the memory system. Alternatively, the placeholder might simply be a blank space reserved for the missing data, or perhaps a simple empty rectangle.

In one embodiment, the control module 211 maintains a value called its “top item index” which is initially 0. When the control module 211 is asked to layout its records in the scrollable window, the control module 211 renders visual representations of data items from the memory system 201, one record at a time, starting with the record identified by the top item index. Each of these visual representations is measured, and the process continues for the next record, and the next, until the scrollable window has filled its available space, or the end of the data set has been reached.

Vertical scrolling is achieved by changing the “top item index” value of the control module 211, which may cause further data to be extracted from the data source 212 and allowing the layout logic to recreate the display. In one embodiment, there is an interface between the data source and the control module that includes the following data:
The starting index and page size (number of records in a page) which indicates the records that are desired by the control for display purposes (these values are written by the control module and observed by the data source);
A collection of data values from the data source that reflects the data source's current ability to provide the requested values (this collection is updated by the data source and observed by the control); and
The total count of values that are ultimately available from the data source (this value is updated by the data source and observed by the control)

The control module 211 requests data from the data source 212 by modifying the starting index and/or page size values, ensuring that the requested item's index is within that range. Immediately upon modification of these values, the data source must make appropriate modifications to the collection of data items, such that it accurately represents the index position and number of items in that range.

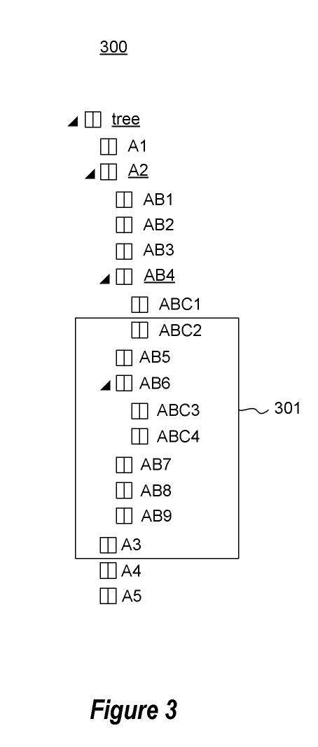

In one embodiment, the data source includes multiple constituent data sources, and the data set is distributed across multiple constituent data sources. In that case, the control module identifies which of the data sources contain portions of the data to be loaded into the memory system, and makes requests from the constituent data sources accordingly. One example of a data source that includes multiple data sources is a hierarchically-structured data source in which the constituent data sources are structured hierarchically with respect to each other. An example of such a hierarchically structured data source will be described with respect to the data source structure 300 of FIG. 3.

In the case of a hierarchically-structured data source, the control module estimates which of the data sources to request data from, and which data to request for each of such data sources in order to display a flattened portion of the data set in the scrollable window. The control module does this by calculating the current position of the scrollable window within an at least partially flattened version of the hierarchically structured data sources. In the example that follows, the control module calculates the current position of the scrollable window by navigating through the hierarchically structured data sources from one end of the hierarchically structured data source. In the case of FIG. 3, which will now be described as an example, this occurs by working from the top of the hierarchically structured data source.

Referring to FIG. 3, the hierarchically-structured data source 300 includes a tree of data sources including a parent data source called “tree”, which has children data sources A1, A2, A3, A4 and A5. Data source A2 also includes child data sources AB1, AB2, AB3, AB4, AB5, AB6, AB7, AB8 and AB9. Of these data sources, data source AB4 has child data sources ABC1 and ABC2, and data source AB6 has child data sources ABC3 and ABC4. Note that the data source 300 is just an example, as the principles described herein may apply to any hierarchically-structured data source of any size or form.

Assume, for purposes of example, that the control module determines that the scrollable window is to display starting at index position 8, having a page size of 9. This page is represented by the content of box 301. To formulate the proper request for data, the control module determines which data source to request which data from by navigating from top down through the hierarchy. In the example that follows, the hierarchy is navigated in fully expanded form, although that is not required.

The control module does this navigation, in this example, by starting with an index position of 0. Here, the control module finds the parent data source called “tree, which has five child data sources. In response to a determination that a data source is encountered that has child data source and the data source is expanded in the hierarchy to expose the child data sources, the control module pushes that data source onto a stack, and moves to the first child data source. In response to a determination that a data source is encountered that is the last child data source, the stack is popped one level. Thus, since the data source “tree” is expanded, the data source “tree” is pushed onto the stack along with the index position and identity of child data sources (in this case, data source A1, A2, A3, A4 and A5). The control module then increments its overall index count to 1, begins an index count for the data source “tree” at 0, and looks at the first child data source A1.

Upon encountering data source A1 at overall index position 1 (and at “tree” index 0), the control module determines that the data source does not have children data sources. Accordingly, there is no push activity or pop activity on the stack, but instead the overall index position increments to 2 (and the “tree” index position increments to 1), and the control module proceeds to the next child data source A2 listed in the present stack.

Upon encountering data source A2 at index position 2 (and at “tree” index 1), the control module determines that the data source does have children data sources, and that the data source were expanded. Accordingly, the data source A2 is pushed onto the stack, along with “tree” index position of 1, and along with the identity of its children AB1, AB2, AB3, AB4, AB5, AB6, AB7, AB8 and AB9. The control module thus increments the overall index position to index position 3 (and establishes an A2 index position of 0), and moves to the first child data source in the augmented stack.

If the data source A2 were current not expanded, it would be simply treated as though it did not have children data sources. Specifically, the overall and “tree” index positions would each be incremented, and the control module would proceed to the next child data source A3 in the “tree” data source. Thus, data sources may be treated differently in this mariner depending on whether they are expanded or not, with data sources that are not expanded being treated as though they had no child data sources. In this case, the A2 data source is expanded, and the entire hierarchy is expanded.

Upon encountering data source AB1 at overall index position 3 (and at A2 index position 0), the control module determines that the data source AB1 does not have children data sources. Accordingly, there is no push activity or pop activity on the stack, but instead the overall index position increments to 4 (and the A2 index increments to 1), and the control module proceeds to the next child data source AB2 listed in the present stack.

Upon encountering data source AB2 at overall index position 4 (and at A2 index position 1), the control module determines that the data source AB2 does not have children data sources. Accordingly, there is no push activity or pop activity on the stack, but instead the index position increments to 5 (and the A2 index is incremented to 2), and the control module proceeds to the next child data source AB3 listed in the present stack.

Upon encountering data source AB3 at overall index position 5 (and at A2 index position 2), the control module determines that the data source AB3 does not have children data sources. Accordingly, there is no push activity or pop activity on the stack, but instead the index position increments to 6 (and the A2 index is incremented to 3), and the control module proceeds to the next child data source AB4 listed in the present stack.

Upon encountering data source AB4 at index position 6 (and at A2 index position 3), the control module determines that the data source AB4 does have children data sources (and is expanded). Accordingly, the data source AB4 is pushed onto the stack, along with the A2 index position of 3, and along with the identity of its children data sources ABC1 and ABC2. The control module thus increments the overall index position to index position 7, establishes an AB4 index position of 0, and moves to the first child data source ABC1 in the augmented stack.

Upon encountering data source ABC1 at index position 7 (and at AB4 index position of 0), the control module determines that the data source ABC1 does not have children data sources. Accordingly, there is no push activity or pop activity on the stack, but instead the overall index position increments to 8 (and increments the AB4 index position to 1), and the control module proceeds to the next child data source ABC2 listed in the present stack.

Here, at overall index position 8 (and at AB4 index position 1), the control module recognizes that the data source ABC2 resides at the highest position in the page of size 9. Recognizing that ABC2 is the final child data source in the present stack, the control module requests the data source ABC2 (representing a record) from data source AB2 to be loaded into memory. The resulting data is the first record entry in the scrollable window and is kept in memory while being displayed. In addition, since the data source ABC2 is the final child data source in the stack, the stack pops one level, such that pop exposes data source A2 at the top of the stack, along with an A2 index position of 3, and along with the identification of each of its children AB1, AB2, AB3, AB4, AB5, AB6, AB7, AB8 and AB9. The control module moves to the next child data source AB5 in the stack, increments the overall index position to 9, and increments the A2 index position to 4.

Upon encountering data source AB5 at overall index position 9 (and at A2 index position 4), since data source AB5 is within the range to be displayed in the window (at position 2 of 9), data source AB5 is added as the first in a list of records that are to be requested from the data source A2. Furthermore, the control module determines that the data source AB5 does not have children data sources. Accordingly, the control module increments to overall index position 10 (and increments the A2 index position to 5), and proceeds to the next child data source AB6 listed in the present stack.

Upon encountering data source AB6 at overall index position 10 (and at A2 index of 5), since data source AB6 is within the range to be displayed in the window (at position 3 of 9), data source AB6 is added as the second in a list of records that are to be requested from the data source A2. In addition, the control module determines that the data source AB6 does have child data sources (and is expanded). Accordingly, the control modules pushes the data source AB6 on the stack, along with the A2 index position of 5, and along with a list of its child data sources ABC3 and ABC4. The control module then increments to overall index position 11, establishes an AB6 index position of 0, and proceeds to the first child data source ABC3 listed in the present stack.

Upon encountering data source ABC3 at overall index position 11 (and AB6 index position 0), since data source ABC3 is within the range to be displayed in the window (at position 4 of 9), data source ABC3 is added as the first in a list of records that are to be requested from the data source AB6. Furthermore, the control module determines that the data source ABC3 does not have children data sources. Accordingly, the control module increments to overall index position 12, increments AB6 index position to 1, and proceeds to the next child data source ABC4 listed in the present stack.

Upon encountering data source ABC4 at index position 12 (and at AB6 index position 1), since data source ABC4 is within the range to be displayed in the window (at position 5 of 9), data source ABC4 is added to the list of records that are to be requested from the data source AB6. Furthermore, the control module determines that the data source ABC4 does not have children data sources. Realizing now that data source ABC4 is the last child data source listed for the data source AB6 at the top of the stack, the control module requests the list of child data sources ABC3 and ABC4 from the data source AB6, and the stack pops one level, which returns data source A2 to the top of the stack, along with the current A2 index position 5, and along with its list of child data sources AB1, AB2, AB3, AB4, AB5, AB6, AB7, AB8 and AB9. Accordingly, the control module increments to overall index position to 13, and increments the A2 index position to 6, and proceeds to the next child data source AB7 in the reduced stack.

Upon encountering data source AB7 at overall index position 13 (and A2 index position 6), since data source AB7 is within the range to be displayed in the window (at position 6 of 9), data source AB7 is added to the list of records that are to be requested from the data source A2. Furthermore, the control module determines that the data source AB7 does not have children data sources. Accordingly, the control module increments to overall index position 14, increments A2 index position to 7, and proceeds to the next child data source AB8 listed in the present stack.

Upon encountering data source AB8 at overall index position 14 (and A2 index position 7), since data source AB8 is within the range to be displayed in the window (at position 7 of 9), data source AB8 is added to the list of records that are to be requested from the data source A2. Furthermore, the control module determines that the data source AB8 does not have children data sources. Accordingly, the control module increments to overall index position 15, increments A2 index position to 8, and proceeds to the next child data source AB9 listed in the present stack.

Upon encountering data source AB9 at index position 15 (and at A2 index position 8), since data source AB9 is within the range to be displayed in the window (at position 8 of 9), data source AB9 is added to the list of records that are to be requested from the data source A2. Furthermore, the control module determines that the data source AB9 does not have children data sources. Realizing now that data source AB9 is the last child data source listed for the data source A2 at the top of the stack, the control module requests the list of child data sources AB5, AB6, AB7, AB8 and AB9 from the data source A2, and the stack pops one level, which returns data source “tree” to the top of the stack, along with the current “tree” index position of 1, and along with its list of child data sources A1, A2, A3, A4 and A5. Accordingly, the control module increments to overall index position to 16, increments the “tree” index position to 2, and proceeds to the next child data source A3 in the reduced stack.

Upon encountering data source A3 at overall index position 15 (and “tree” index position 2), since data source A3 is within the range to be displayed in the window (at position 9 of 9), data source A3 is added to the list of records that are to be requested from the “tree” data source. Now, since all of the data sources are determined which are to be used to populate the scrollable window, the record corresponding to data source A3 is requested from the “tree” data source.

At this point, all of the data is retrieved into memory, and the flattened hierarchy of records may be displayed in the scrollable window. Whenever the window is scrolled, this analysis may be repeated to acquire the appropriate records from the hierarchical set of data sources.

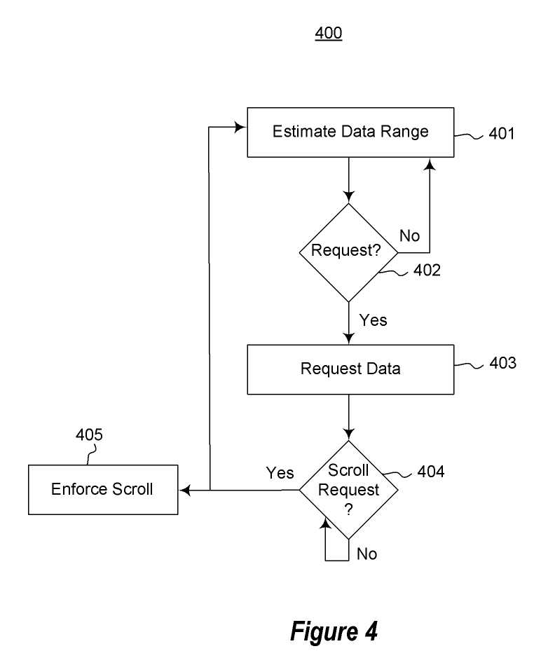

FIG. 4 illustrates a flowchart of a method 400 for a computing system to manage a scrollable window. The management occurs by repeatedly estimating data ranges of a data set that is to be either presently displayed or that may be soon displayed in a scrollable window based on scrolling activity associated with the scrollable window (act 401). If the estimation results in a determination that a further request is to be made for data (Yes in decision block 402), then further data is requested from the data source to be loaded into the memory system. Otherwise (No in decision block 402, the system continues to estimate the data range needed (act 401). After requesting the data (act 403), there might still be further scrolling activity (Yes in decision block 404). In that case, the scroll is enforced (act 405) immediately, rather than waiting for the data before the scroll is enforced. In the meantime, the data range is estimated (act 401), and if further data is needed to populate the new state of the scrolled window (Yes in decision block 402), that data is requested (act 403).

Thus, a mechanism is described for permitting a portion of data sets to be loaded from persistent storage into memory to appear in a scrollable window that is scrollable throughout the data set, without requiring the entire data set be loaded into the memory system at one time. Furthermore, the scrolling function may be enforced even if data is not yet present in memory to be rendered in the scrollable window. Thus, users feel scrollable control over windows that are populated by data sets that are not loaded into memory.

The present invention may be embodied in other specific forms without departing from its spirit or essential characteristics. The described embodiments are to be considered in all respects only as illustrative and not restrictive. The scope of the invention is therefore, indicated by the appended claims rather than by the foregoing description. All changes which come within the meaning and range of equivalency of the claims are to be embraced within their scope.

What is claimed is:

1. A computer program product comprising one or more physical computer-readable media having thereon computer-executable instructions that, when executed by one or more processors of the computing system, cause the computing system to instantiate the following:
a control module configured to manage scrollable windows by repeatedly estimating data ranges of the data set that are to be either presently displayed or that may be soon displayed in a scrollable window, and loading such estimated data ranges from the data source into the memory system without loading the entire data set from the data source such that only a portion of the data set is present in the memory system at any given time.

2. The computer program product in accordance with claim 1, wherein the control module is configured to enforce a scrolling function of the scrollable window even if not all of the data to be displayed in the scrolled state of the scrollable window is yet loaded from the data source into the memory system.

3. The computer program product in accordance with claim 2, wherein if not all of the data to be displayed in the scrolled state of the scrollable window is yet loaded from the data source into the memory system, the control module is configured to display a placeholder for the missing data in the scrollable window until the missing data is loaded into the memory system, when the missing data is then displayed in lieu of the placeholder.

4. The computer program product in accordance with claim 3, wherein the placeholder includes a progress indicator representing a status of the loading of the missing data from the data source into the memory system.

5. The computer program product in accordance with claim 3, wherein the placeholder does not include a progress indicator representing a status of the loading of the missing data from the data source into the memory system.

6. The computer program product in accordance with claim 1, wherein if the data source comprises a plurality of hierarchically structured data sources, the control module estimates which of the plurality of data sources to requested data from, and which data to request for each of such data sources in order to display a flattened portion of the data set in the scrollable window.

7. The computer program product in accordance with claim 6, wherein the control module estimates which of the plurality of data sources to request data from by calculating a position of a current position of the scrollable window within an at least partially flattened version of the hierarchically structured data sources.

8. The computer program product in accordance with claim 7, wherein the control module calculates the current position of the scrollable window by navigating through the hierarchically structured data sources from one end of the hierarchically structured data source.

9. The computer program product in accordance with claim 1, wherein the data source provides a total number of records in the data set to thereby allow the control module to render corresponding process in a scroll bar of a scrollable window.

10. The computer program product in accordance with claim 1, wherein the control module requests a portion of the data set from the data source by index and size.

11. The computer program product in accordance with claim 1, wherein the data source comprises a plurality of data sources, and the data set is distributed amongst at least some of the plurality of data sources.

12. The computer program product in accordance with claim 1, wherein the control module is configured to identify which of the plurality of data sources contains a portion of the data set that is to be loaded into the memory system.

13. The computer program product in accordance with claim 1, wherein the data is presented in the scrollable window in the form of a list.

14. The computer program product in accordance with claim 1, wherein the data is presented in the scrollable window in the form of a table.

15. A computing system comprising:
a display;
a memory system;
a data source including a data set; and
a control module configured to manage a scrollable window being displayed on the display by repeatedly estimating data ranges of the data set that are to be either presently displayed or that may be soon displayed in the scrollable window, and loading such estimated data ranges from the data source into the memory system without loading the entire data set from the data source such that only a portion of the data set is present in the memory system at any given time.

16. The computing system in accordance with claim 15, wherein the control module is configured to enforce a scrolling function of the scrollable window even if not all of the data to be displayed in the scrolled state of the scrollable window is yet loaded from the data source into the memory system.

17. The computing system in accordance with claim 15, wherein the data source comprises a plurality of hierarchically structured data sources, such that the control module estimates which of the plurality of data sources to requested data from, and which data to request for each of such data sources.

18. The computing system in accordance with claim 15, wherein the control module comprises at least one processor responding to computer-executable instructions.

19. The computing system in accordance with claim 18, wherein the computer-executable instructions are within the memory system.

20. A method for a computing system to manage a scrollable window, the method comprising:
an act of repeatedly estimating data ranges of a data set that is to be either presently displayed or that may be soon displayed in a scrollable window based on scrolling activity associated with the scrollable window;
loading such estimated data ranges from a data source into a memory system without loading the entire data set from the data source such that only a portion of the data set is present in the memory system at any given time; and
an act of enforcing a scrolling function of the scrollable window even if not all of the data to be displayed in the scrolled state of the scrollable window is yet loaded from the data source into the memory system.
